(19) United States
(12) Patent Application Publication
(10) Pub. No.: US 2007/0181400 A1
(43) Pub. Date: Aug. 9, 2007

(54) Roller assembly and method of making

(75) Inventor: Brian Evans, Marshfield, MA (US)

Correspondence Address: MICHAUD-DUFFY GROUP LLP, 306 INDUSTRIAL PARK ROAD, SUITE 206, MIDDLETOWN, CT, 06457, US

(73) Assignee: Globe Composites Solutions, LTD, Dallas, TX (US)

(21) Appl. No.: 11/654,282

(22) Filed: Jan. 16, 2007

Related U.S. Application Data
(60) Provisional application No. 60/765,452, filed on Feb. 6, 2006.

(51) Int. Cl. B65G 13/00

(52) U.S. Cl. 193/37

(57) ABSTRACT

A roller may have a roller cylinder having two ends and an axle assembly in at least one end of the roller cylinder. The axle assembly has an axle stub extending out from the roller cylinder and rotatably mounted therein by two spaced-apart bearings. In another aspect, an axle cartridge for a roller includes a sleeve having a length and having two ends and two bearings mounted in the sleeve, spaced-apart from each other. An axle stub is mounted in the bearings for rotation relative to the sleeve, the axle stub being configured to protrude from the sleeve. A roller may be manufactured by mounting an axle cartridge as described herein in each end of a roller cylinder.

### CROSS REFERENCE TO RELATED APPLICATION

This application claims the benefit of U.S. provisional application No. 60/765,452, filed Feb. 6, 2006, the contents of which are incorporated herein by reference in their entirety.

### BACKGROUND

The invention relates to conveyor systems that facilitate the movement of goods or packages of goods, and in particular to roller conveyors.

Conventional roller conveyors are made primarily from metal, e.g., steel, and they are commonly constructed and assembled in sections that are linked together end-to-end at the location of use. Increasingly, packages of goods are identified by RFID (Radio Frequency Identification) tags that emit radio signals to permit tracking the handling of the package. However, conventional conveyors, being made of steel, interfere with the RFID tag signals. Some attempts have been made to provide substantially RFID transparent conveyor sections.

Based on the foregoing, it is the general object of this invention to provide a roller assembly that improves upon, or overcomes the problems and drawbacks of prior art roller conveyors.

### SUMMARY OF THE INVENTION

The present invention resides in one aspect in a roller that comprises a roller clylinder having two ends and an axle assembly secured to at least one end of the roller cylinder. The axle assembly comprises an axle stub extending out from the roller cylinder and rotably mounted therein by two spaced-apart bearings.

In another aspect, the invention provides an axle cartridge for a roller. The cartridge comprises a sleeve having a length and having two ends and two bearings mounted in the sleeve, spaced-apart from each other. An axle stub is mounted in the bearings for rotation relative to the sleeve, the axle stub being configured to protrude from the sleeve.

The present invention resides in another aspect in a method of manufacturing a roller, by mounting an axle cartridge as described herein in each end of a roller cylinder.

### BRIEF DESCRIPTION OF THE DRAWINGS

FIG. 1 is a schematic cross-sectional view of one embodiment of roller as described herein; and

FIG. 2 is a schematic cross-sectional view of one embodiment of an axle assembly as described herein;

FIG. 3A is a view similar to that of FIG. 2 of an alternative embodiment of an axle assembly;

FIG. 3B is a view similar to that of FIG. 3A of another alternative embodiment of an axle assembly;

FIG. 4 is an elevation view of a conveyor section comprising one or more rollers as described herein; and

FIG. 5 is a schematic perspective view of a conveyor assembly comprising the conveyor section of FIG. 4.

### DETAILED DESCRIPTION OF THE INVENTION

This invention provides improvements in roller conveyors, including improved rollers and roller conveyor sections. In one aspect, this invention provides a conveyer that avoids interference with RFID signals by providing a conveyor section made from a material that is substantially RFID transparent to radio signals at frequency ranges between 30 KHz to 500 KHz (low frequency), 850 MHz to 950 MHz, and 2.4 GHz to 2.5 GHz (both considered ultra high frequency). Such materials include synthetic polymeric materials. At least one conveyor section made from this material may be incorporated into a conveyor line to provide an RFID- friendly zone of the conveyer where RFID signals may be received by RFID readers without interference from the conveyor.

In another aspect, the invention provides a new design for a roller conveyor. In an optional embodiment, the roller comprises, and may be made substantially from, substantially RFID-transparent materials. In certain embodiments, the roller includes a roller cylinder and an axle assembly as described herein at one or both ends of the roller. Optionally, the axle assembly can be constructed as a self-contained unit, referred to herein as a cartridge, that can be assembled apart from the roller cylinder and may then be mounted in the end of the cylinder.

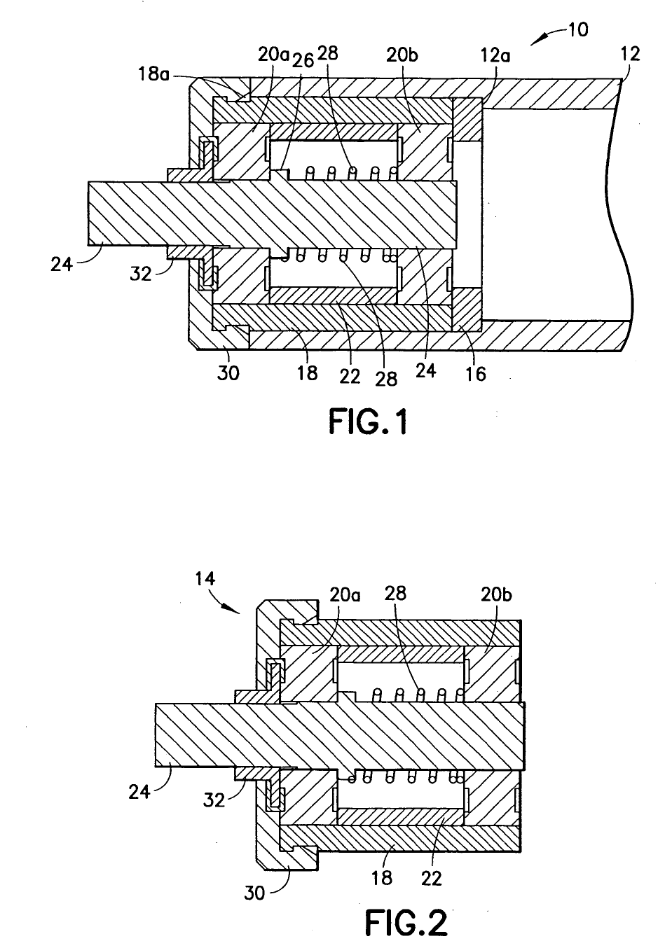

One roller suitable for use in a roller conveyor is shown schematically in FIG. 1 and is generally designated by the reference numeral 10. Roller 10 comprises a roller cylinder 12 which, in the illustrated embodiment, is a tubular shell and which has an internal shoulder 12a formed at each end to seat an axle assembly 14 (FIG. 2), whereby the axle assembly is secured to the roller cylinder 12. A seat washer 16 is positioned against shoulder 12a to provide an improved seat for the axle assembly 14.

The axle assembly 14 comprises a sleeve 18 by which the assembly 14 is secured in cylinder 12 by adhesive or the like. Sleeve 18 may be dimensioned and configured for a friction fit with cylinder 12. In addition, as seen in FIG. 2, the sleeve 18 has two ends and there are two bearings 20a, 20b disposed therein and spaced apart from each other therein by a tubular spacer 22. Bearings 20a and 20b are sized for a friction fit in sleeve 18. Tubular spacer 22 may be a distinct structure from cylinder 12, as shown, or it may be formed integrally with cylinder 12.

The axle assembly 14 comprises an axle stub 24 rotatably mounted in the bearings 20a, 20b. The axle stub has a positioning ferrule 26 thereon, between the bearings. A spring 28 is compressed against bearing 20b and the positioning ferrule 26 to bias the axle stub 24 away from bearing 20b so that the ferrule 26 presses against bearing 20a and axle stub 24 protrudes through bearing 20a. The spring may be a conventional metal compression spring. By virtue of the spring 28, the axle stub 24 can be depressed into roller cylinder 12 against the force of the spring 28, and it will thereafter recover by protruding outward from cylinder 12 under the impetus of the spring. As discussed below, this feature is useful for mounting the roller between supporting side rails.

The sleeve 18 has a groove 18a therein by which an end cap 30 mechanically engages the sleeve 18. In addition, or instead of mechanical engagement, cap 30 may simply be cemented to sleeve 18. In the latter case, there is no need for groove 18a.

The end cap 30 comprises an aperture to permit axle stub 24 to extend therethrough. A shaft spacer 32 may mounted on axle stub 24 and may be held in place by end cap 30. The shaft spacer 32 may serve as to limit the depth to which axle stub 24 can be inserted into a mounting aperture on a mounting structure (such as a conveyor side rail). Thus, the shaft spacer 32 maintains a set-off distance between the mounting structure and the end cap 30, and as cylinder 12 rotates, the spacer 32 will prevent the end cap 30 from rubbing against the mounting structure.

By mounting axle stub 24 in two spaced-apart bearings, the roller can bear significantly more weight than if only one bearing were used. In addition, it is easier to assure that the axle stub is properly oriented in the roller cylinder (i.e., coaxially with the cylinder) and that the axle stub will resist deflection in response stress imposed by items on the roller than if only one bearing were used. These advantages are especially valuable in embodiments in which the axle stub is axially displaceable within the roller cylinder, e.g., against the bias of a spring.

Axle assembly 14 may be pre-assembled as an axle cartridge that can easily be inserted into the end of the cylinder 12. An axle cartridge comprises, at least, an axle stub rotatably mounted in a sleeve by two spaced-apart bearings. In one embodiment, bearing 20b is mounted in sleeve 18, then spacer 22 is inserted into the sleeve 18. The axle stub 24 with spring 28 thereon is inserted, into bearing 20b, and then bearing 20a is inserted into sleeve 18 with axle stub 24 extending therethrough. After that, shaft spacer 32 and end cap 30 are placed over the protruding end of axle stub 24 and are secured to sleeve 18. The resulting assembly is self-contained and may easily be secured in the end of a roller cylinder.

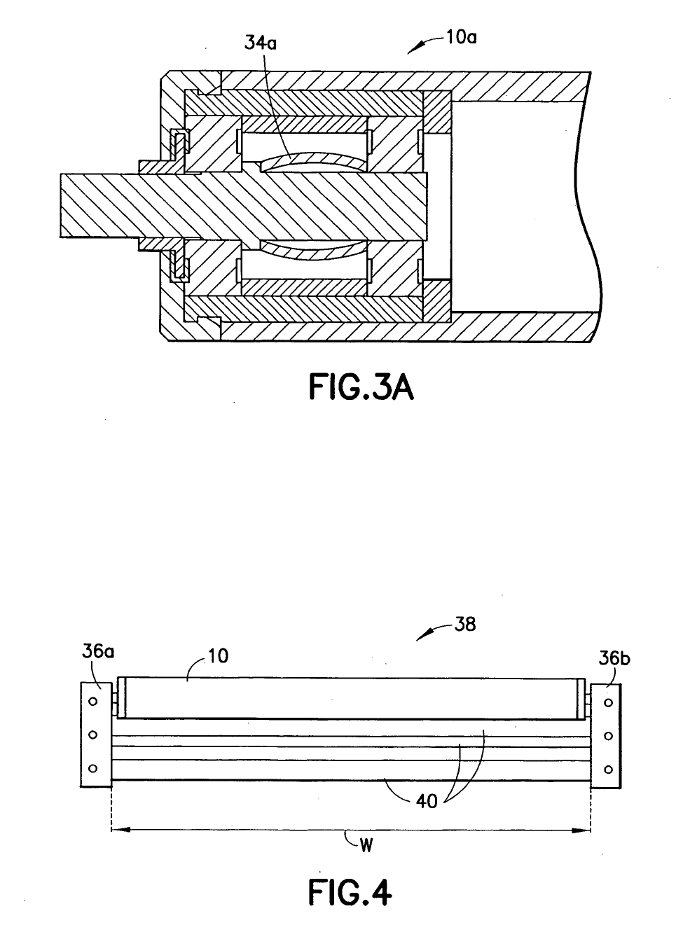

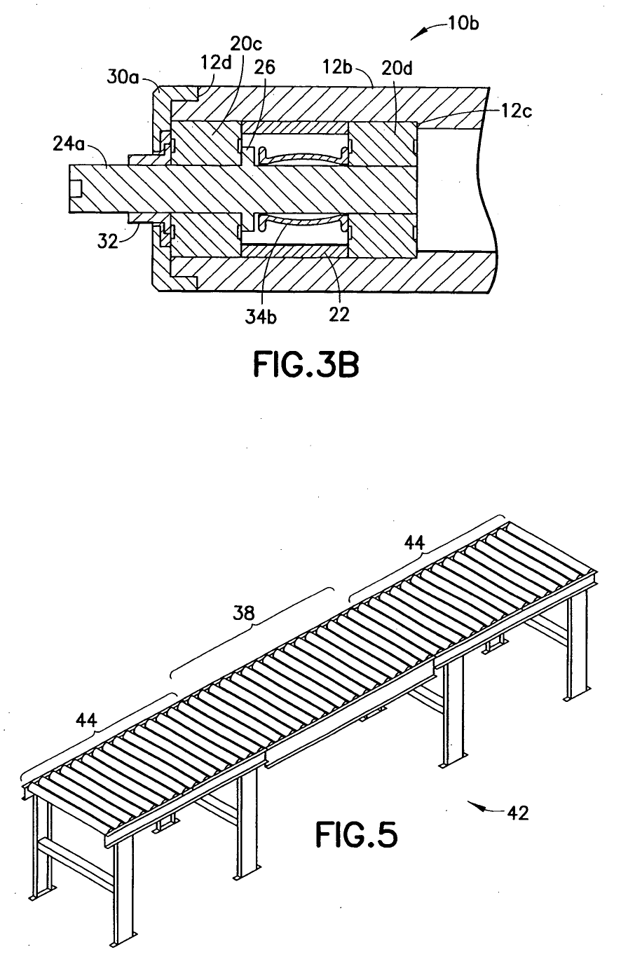

As stated above, in one embodiment, roller 10 is substantially made from RFID-transparent material, e.g., one or more synthetic polymeric materials. Thus, most, if not all, of cylinder 12, sleeve 18, spacer 22, axle stub 24, end cap 30 and shaft spacer 32 may be formed from a composite polymer that may be based on a polyurethane material and that may optionally contain suitable additives that may be thermoplastics, polyaramids (such as KEVLAR® polyaramid), polyesters and the like. Bearing 20a may comprise plastic races and glass balls. Such bearings are known in the art and are commercially available. Even in an otherwise metal-free embodiment, spring 28 may be a metal spring, since it will constitute such a small proportion of the total mass of the roller. Alternatively, metal spring 28 may be replaced by a urethane barrel spring 34a, as shown in roller 10a, seen in FIG. 3A.

In another alternative embodiment, a roller may be constructed without a sleeve or seat washer. For example, roller 10b in FIG. 3B comprises a cylinder 12b having an internal shoulder 12c therein. Bearing 20d is disposed in cylinder 12b seated directly against shoulder 12c. The axle stub 24a, which has a urethane barrel spring 34b thereon and which comprises a positioning ferrule 26 formed thereon, is inserted into bearing 20d. A second bearing 20c is also disposed in cylinder 12b on axle stub 24a. Bearing 20c is spaced-apart from bearing 20d due to the intervening tubular spacer 22. Bearing 20c is positioned so that positioning ferrule 26 will be pressed against bearing 20c by spring 34b. Cylinder 12b has an external shoulder 12d that is dimensioned and configured to serve as a seat for an end cap 30a, through which axle 24a extends. Roller 10b includes a spacer 32 for axle stub 24a. Roller 10b is seen to contain fewer parts than rollers 10 or 10a.

One or more rollers such as roller 10, 10a or 10b may be mounted between two side rails 36a, 36b, to provide a conveyor section 38 as shown in FIG. 4. The side rails 36a, 36b are supported structurally by rail spacers 40, which extend between the inside surfaces of side rails 36a, 36b (i.e., those surfaces of the side rails that face the spacers 40) and keep side rails 36a, 36b at a fixed distance W apart from each other. A roller sized for mounting therein comprises a roller cylinder whose length is less than distance W and has axle stubs that protrude from each end for a total length greater than W, so that the axle stubs can be inserted into mounting apertures in the side rails. To mount roller 10 therein, the axle stub 24 can be moved inward of cylinder 12 against the force of the spring 28 for a distance sufficient to provide clearance between the end of axle stub 24 and the inside surfaces of the side rails 36a, 36b. Once the stub is aligned with the appropriate mounting aperture in the side rail, the stub is allowed to move outward under the force of the spring, to dispose the axle stub in the mounting aperture.

In one embodiment, the portion of axle stub 24 protruding from cylinder 12 has a geometric configuration that is keyed to an aperture in a side rail so that the axle stub 24 is inhibited from rotating relative to the side rails. For example, axle stub 24 may have a hexagonal cross-sectional configuration that may be sized to fit in a hexagonal mounting aperture in a side rail 36a. To facilitate the assembly of axle assembly 14 and conveyor section 38, the protruding portion of axle stub 24 may be tapered, preferably to a flat truncated end rather than to a point. The bearings 20a, 20b permit the cylinder 10 to rotate relative to the side rails even if the axle stubs do not rotate.

In a preferred embodiment, side rails 36a, 36b and spacers 40 comprise substantially RFID-transparent materials.

As seen in FIG. 5, the conveyor section 38 may be used as part of a conveyor assembly 42 that comprises one or more other conveyor sections 44. The conveyor sections in the conveyor assembly may be equipped with interlocking flanges or brackets for interconnecting conveyor sections end-to-end. One or more conveyor of the other conveyor sections 44 may be constructed in the same way and from the same materials as section 38, or they may comprise other materials, optionally metal, and may differ in construction from section 38. In either case, conveyor section 38 provides an RFID-friendly region in conveyor section 38 where RFID signals from packages can be transmitted from items thereon without interference from the conveyor section 38. Thus, conveyor section 38 facilitates the use of RFID tags for items on the conveyor.

Roller 10 is configured for passive rolling, i.e., bearings 20a, 20b permit it to be rolled by an item resting thereon as the item moves under the force of gravity, momentum or as a result of being pushed on the conveyor. In an alternative embodiment, the cylinder 12 may be configured to have a recess formed in the surface thereof for receiving a drive belt. The drive belt may be connected to a drive motor so that an item on the roller can be moved by the roller.

Although the invention has been described with reference to particular embodiments thereof, it will be understood by one of ordinary skill in the art, upon a reading and understanding of the foregoing disclosure that numerous variations and alterations to the disclosed embodiments will fall within the spirit and scope of this invention and of the appended claims.

What is claimed is:

1. A roller comprising:
a roller cylinder having two ends; and an axle assembly secured to at least one end of the roller cylinder, the axle assembly comprising an axle stub extending out from the roller cylinder and rotatably mounted therein by two spaced-apart bearings.

2. The roller of claim 1, wherein the axle stub is axially slidable relative to the bearings, inwardly and outwardly from the end of the roller cylinder, the axle stub comprising a positioning ferrule between the bearings, the axle assembly further comprising a spring between a bearing and the positioning ferrule for biasing the axle stub outward of the roller cylinder.

3. The roller of claim 1, wherein the roller is substantially formed of substantially RFID-transparent material.

4. The roller of claim 2, further comprising a spacer between the bearings.

5. The roller of claim 2, wherein the spring is a metal spring.

6. The roller of claim 2, wherein the spring is a non-metal spring.

7. An axle cartridge for a roller, comprising:
a sleeve having a length and having two ends;
two bearings mounted in the sleeve, spaced-apart from each other;
an axle stub mounted in the bearings for rotation relative to the sleeve, the axle stub being configured to protrude from the sleeve

8. The axle cartridge of claim 7, wherein the axle stub is slidably mounted in the bearings and comprises a positioning ferrule, the cartridge further comprising a spring compressed between the ferrule and a bearing to bias the axle stub to protrude from the sleeve.

9. The roller of claim 7, further comprising a roller end cap mounted on the sleeve, the roller end cap having an opening therein and being positioned such that the axle stub protrudes therethrough.

10. The roller of claim 7, wherein the sleeve, bearings and axle stub are formed from substantially RFID transparent material.

11. The roller of claim 7, wherein the spring, sleeve, bearings and axle stub are formed from substantially RFID transparent material.

12. A method of making a roller, comprising mounting an axle cartridge according to claim 7 in each end of a roller cylinder.
